(19) United States
(12) Patent Application Publication
(10) Pub. No.: US 2021/0213475 A1
(43) Pub. Date: Jul. 15, 2021

(54) PUMP OF AGRICULTURAL PLANT PROTECTION MACHINE AND AGRICULTURAL PLANT PROTECTION MACHINE

(71) Applicant: SZ DJI SOFTWARE TECHNOLOGY CO., LTD., Shenzhen (CN)

(72) Inventors: Zhan SHU, Shenzhen (CN); Le ZHOU, Shenzhen (CN); Xiaolong WU, Shenzhen (CN)

(21) Appl. No.: 17/218,005

(22) Filed: Mar. 30, 2021

Related U.S. Application Data
(63) Continuation of application No. PCT/CN2018/109195, filed on Sep. 30, 2018.

(51) Int. Cl. B05B 12/08; F04B 53/10; F04B 23/02; F04B 49/24; B05B 9/04; B05B 13/00; A01G 25/09; A01M 7/00; B64C 39/02

(52) U.S. Cl. CPC B05B 12/087; F04B 53/10; F04B 23/02; F04B 49/24; B64C 39/024; B05B 13/005; A01G 25/09; A01M 7/0042; B05B 9/0403

(57) ABSTRACT

The present disclosure provides an agricultural plant protection machine. The machine includes a frame, a liquid storage tank for storing liquid, a pipeline connected to the liquid storage tank, a nozzle, and a pump for pumping the liquid in the liquid storage tank to the nozzle. The pump includes a pump body including a liquid inlet, a liquid outlet, and a pressure relief port; a pressure relief device disposed at the pressure relief port, the pressure relief device including a valve and an elastic reset member, the valve being disposed corresponding to the pressure relief port for sealing the valve. In response to a hydraulic pressure in the pump body exceeding a preset pressure threshold, the valve is separated from the pressure relief port under the force of the liquid and the liquid flows out of the pressure relief port.

### CROSS-REFERENCE TO RELATED APPLICATIONS

This application is a continuation of International Application No. PCT/CN2018/109195, filed on Sep. 30, 2018, the entire content of which is incorporated herein by reference.

### TECHNICAL FIELD

The present disclosure relates to the technical field of pumps and, more specifically, to a pump of an agricultural plant protection machine and an agricultural plant protection machine.

### BACKGROUND

During the operation of an agricultural plant protection machine, a liquid chemical is generally sprayed from the small holes of the nozzle under the pressure of a pump. When the liquid chemical is accidentally mixed with impurities, the small holes of the nozzle are easily blocked, which causes the hydraulic pressure in the entire spray system to increase, and the rate of increase is proportional to the increase in blockage. When the blockage is severe, the pump or other spraying components are easily damaged. For example, when the pump is a diaphragm pump, excessive hydraulic pressure will cause the diaphragm of the diaphragm pump to be damaged by impact.

Conventional pump generally uses an electronic pressure gauge to detect the pressure. When the pressure rises, the pressure gauge will send a signal to the control center, and the control center will issue a high-pressure warning and stop the pump. The electronic pressure gauge needs time to send the signal, as such, the pump stop protection is often lagging. In addition, the electronic pressure gauge itself is not stable, which often causes failure of the overpressure protection. Further, the cost of electronic pressure gauge is relatively high. It can be seen that conventional pumps have problems of poor timeliness, reliability, and high cost, and during the operation of the agricultural plant protection machine, there is still a risk of damage to the pump or other spraying components due to overpressure caused by the blockage at the nozzle holes.

### SUMMARY

The present disclosure provides an agricultural plant protection machine. The agricultural plant protection machine includes a frame; a liquid storage tank for storing liquid; a pipeline connected to the liquid storage tank; a nozzle; and a pump for pumping the liquid in the liquid storage tank to the nozzle. The pump includes a pump body including a liquid inlet, a liquid outlet, and a pressure relief port, the liquid inlet being connected with the liquid outlet through a flow channel, the liquid inlet being connection with liquid storage tank through the pipeline, the liquid outlet being connected with the nozzle through the pipeline, the pressure relief port being connected to the flow channel; a pressure relief device disposed at the pressure relief port, the pressure relief device including a valve and an elastic reset member, the valve being disposed corresponding to the pressure relief port for sealing the valve, the elastic reset member being connected to the valve to provide an elastic restoring force to the valve and configured to cause the valve to seal the pressure relief port under action of the elastic restoring force. In response to a hydraulic pressure in the pump body exceeding a preset pressure threshold, the valve is separated from the pressure relief port under the force of the liquid and the liquid flows out of the pressure relief port.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a perspective schematic diagram of a pump according to an embodiment of the present disclosure.

FIG. 2 is a partial structural disassembly view of the pump according to an embodiment of the present disclosure.

FIG. 3 is a schematic cross-sectional view of the pump according to an embodiment of the present disclosure.

FIG. 4 is a structural disassembly view of the pump according to another embodiment of the present disclosure.

FIG. 5 is a perspective schematic diagram of the pump according to another embodiment of the present disclosure.

FIG. 6 is a perspective schematic diagram of the pump in another direction according to another embodiment of the present disclosure.

FIG. 7 is a structural disassembly view of the pump according to another embodiment of the present disclosure.

FIG. 8 is a schematic cross-sectional view of the pump according to another embodiment of the present disclosure.

FIG. 9 a perspective schematic diagram of the pump according to another embodiment of the present disclosure.

FIG. 10 is a structural disassembly view of the pump according to another embodiment of the present disclosure.

FIG. 11 is another structural disassembly view of the pump according to another embodiment of the present disclosure.

FIG. 12 is a schematic cross-sectional view of the pump according to another embodiment of the present disclosure.

FIG. 13 a perspective schematic diagram of a motor according to an embodiment of the present disclosure.

FIG. 14 is a schematic cross-sectional view of the motor according to an embodiment of the present disclosure.

FIG. 15 is a partial enlarged view of a part of the structure shown in FIG. 14.

FIG. 16 is a structural disassembly view of the motor according to an embodiment of the present disclosure.

FIG. 17 is another structural disassembly view of the motor according to another embodiment of the present disclosure.

FIG. 18 is s schematic structural diagram of an airborne spray system according to an embodiment of the present disclosure.

FIG. 19 is a schematic structural diagram of an opening of the airborne spray system according to an embodiment of the present disclosure.

FIG. 20 is a schematic structural diagram of a connector of the airborne spray system according to an embodiment of the present disclosure.

FIG. 21 is a schematic diagram of a specific structure of the connector of the airborne spray system according to an embodiment of the present disclosure.

FIG. 22 is a schematic structural diagram of the airborne spray system in another direction according to an embodiment of the present disclosure.

FIG. 23 is a perspective schematic diagram of an agricultural plant protection machine according to an embodiment of the present disclosure.

### REFERENCE NUMERALS

| | |
|---|---|
| 100 | Frame |
| 110 | Body |
| 120 | Landing gear |
| 130 | Arm |
| 200 | Liquid storage tank |
| 300 | Pipeline |
| 400 | Nozzle |
| 500 | Airborne spray system |
| 510 | Fixing frame |
| 511 | Opening |
| 5111 | First opening |
| 5112 | Second opening |
| 520 | Pump |
| 1 | Pump body |
| 11 | Liquid inlet |
| 12 | Liquid outlet |
| 13 | Pressure relief port |
| 14 | Liquid return port |
| 15 | Second protrusion |
| 16 | Second fixed connection part |
| 2 | Pressure relief device |
| 21 | Valve |
| 22 | Elastic reset member |
| 23 | Cover |
| 24 | Adjusting member |
| 25 | Travel switch |
| 26 | Auxiliary member |
| 27 | Fixing member |
| 3 | Diaphragm |
| 4 | Driving mechanism |
| 41 | Motor body |
| 411 | Motor rotor |
| 412 | Motor stator |
| 413 | Electrical interface |
| 414 | Circuit board |
| 42 | Motor base |
| 421 | Pump body mounting surface |
| 422 | Motor mounting surface |
| 423 | Mounting hole |
| 43 | Motor shaft |
| 44 | Protective cover |
| 45 | Static seal |
| 46 | Dynamic seal |
| 461 | First recess |
| 462 | First abutting part |
| 463 | Second abutting part |
| 464 | Third abutting part |
| 465 | Second recess |
| 47 | First bearing |
| 48 | Electrical plug |
| 49 | Sealing structure |
| 410 | Second bearing |
| 420 | Third bearing |
| 5 | Diaphragm support |
| 6 | Transmission mechanism |
| 61 | Eccentric rotating member |
| 62 | Bracket |
| 63 | Connecting part |
| 7 | Gasket |
| 8 | Pump cover |
| 9 | Valve cover |
| 91 | First fixed connection part |
| 92 | First protrusion |
| 10 | First check valve |
| 101 | First valve core |
| 102 | First elastic member |
| 20 | Second check valve |
| 201 | Second valve core |
| 202 | Second elastic member |
| 530 | Connecting piece |
| 531 | Connecting body |
| 532 | Stop |
| 533 | Connecting bracket |
| 540 | Water separator |
| 541 | Auxiliary water tank |
| 550 | Pressure gauge |
| 560 | Mounting bracket |

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure. It should be noted that technical solutions provided in the present disclosure do not require all combinations of the features described in the embodiments of the present disclosure.

Exemplary embodiments will be described with reference to the accompanying drawings. In the case where there is no conflict between the exemplary embodiments, the features of the following embodiments and examples may be combined with each other.

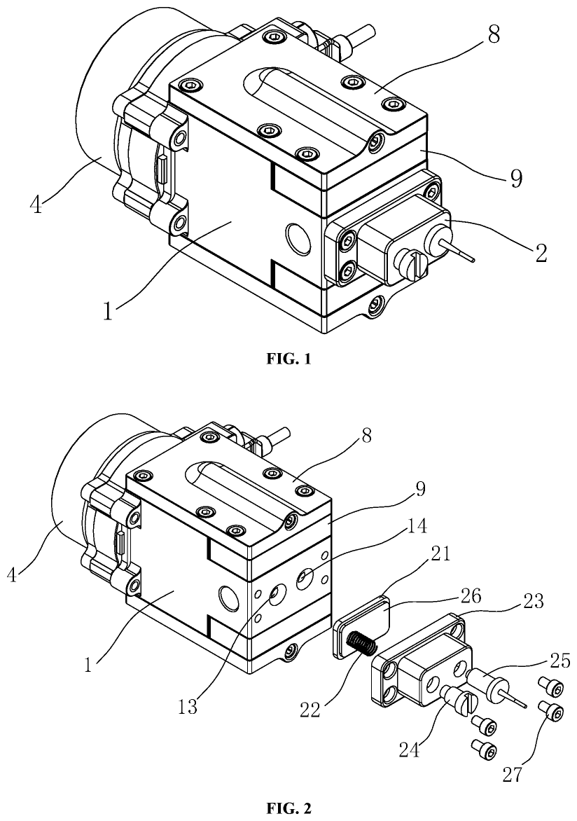

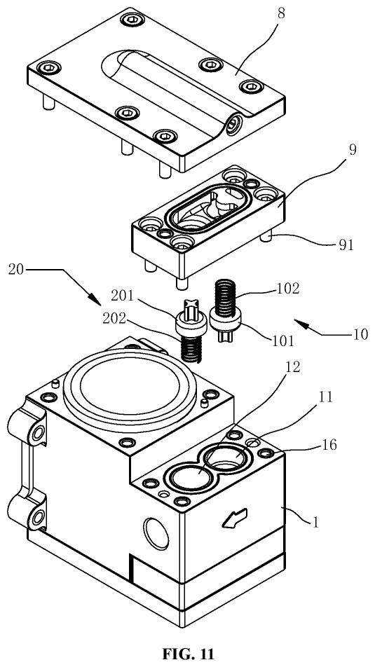

An embodiment of the present disclosure provides a pump, which can be applied to an agricultural plant protection machine. The pump can be used to pump pesticides to the spray head of the agricultural plant protection machine. Referring to FIG. 1 to FIG. 3, a pump 520 includes a pump body 1 and a pressure relief device 2. The pump body 1 includes a liquid inlet 11 (as shown in FIG. 11), a liquid outlet 12 (as shown in FIG. 11), and a pressure relief port 13. The liquid inlet 11 communicates with the liquid outlet 12 through a flow channel, and the pressure relief port 13 communicates with the flow channel. The pressure relief device 2 is disposed at the pressure relief port 13. In some embodiments, the pressure relief device 2 includes a valve 21 and an elastic reset member 22. The valve 21 is disposed corresponding to the pressure relief port 13, and the valve 21 can be used to seal the pressure relief port 13. The elastic reset member 22 is connected to the valve 21, and the elastic reset member 22 can provide an elastic restoring force to the valve 21. Under the action of the elastic restoring force of the elastic reset member 22, the valve 21 can be prompted to seal the pressure relief port 13. When the hydraulic pressure in the pump body 1 exceeds a preset pressure threshold, the valve 21 may be separated from the pressure relief port 13 under the holding force of the pesticide, and the pesticide may flow out from the pressure relief port 13, thereby reducing the hydraulic pressure in the pump body 1.

When the pump 520 works normally, the pesticide enters the flow channel in the pump body 1 from the liquid inlet 11, and the pesticide is pumped to a nozzle 400 through the liquid outlet 12, and the pesticide is sprayed from the nozzle 400. When the nozzle 400 is blocked, the passage between the liquid outlet 12 and the nozzle 400 is cut off, and the pesticide cannot flow from the liquid outlet 12 to the nozzle 400. However, the pesticide still enters the flow channel in the pump body 1 from the liquid inlet 11, which causes the hydraulic pressure in the pump body 1 to increase. When the hydraulic pressure in the pump body 1 exceeds the preset pressure threshold, the pesticide will hold the valve 21. When the holding force of the pesticide exceeds the elastic restoring force exerted on the valve 21 by the elastic reset member 22, the valve 21 may be separated from the pressure relief port 13, and the pesticide may enter the flow channel in the pump body 1 from the liquid inlet 11 and flow out from the pressure relief port 13, thereby realizing the overpressure protection of the pump 520.

In this embodiment, the preset pressure threshold and the holding force are positively related to the elastic restoring force, that is, the greater the elastic restoring force, the greater the preset pressure threshold and the holding force.

Consistent with the present disclosure, by arranging a pressure relief port 13 on the pump body 1, and adding a pressure relief device 2 corresponding to the pressure relief port 13, when the hydraulic pressure in the pump body 1 is too high, the pressure relief device 2 can be separated from the pressure relief port 13, and the liquid in the pump body 1 can flow out through the pressure relief port 13, thereby realizing the overpressure protection of the pump 520. Compared with the expensive electronic pressure gauge 550, the cooperation between the pressure relief device 2 and the pressure relief port 13 has the advantages of low cost, timelier response, and higher stability. In addition, the liquid from the pressure relief port 13 can enter the pump body 1 again through the liquid inlet 11, thereby avoiding the waste of resources and environmental pollution caused by liquid leakage.

The pump body 1 of this embodiment further includes a liquid return port 14. The liquid return port 14 communicates with the flow channel, and the pressure relief port 13 communicates with the liquid return port 14 through a return channel. The pesticides flowing out of the pressure relief port 13 can be re-entered into the flow channel in the pump body 1 through the liquid return port 14, thereby avoiding the waste of resources and environmental pollution caused by liquid leakage.

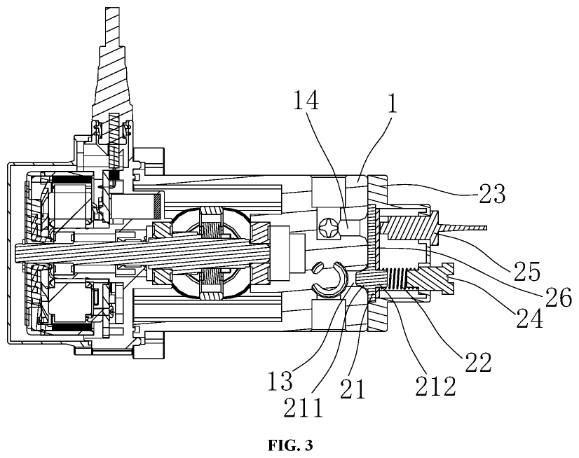

Referring to FIG. 3, a poppet value is disposed on the side of the valve 21 facing the pressure relief port 13, and the poppet value is inserted into the pressure relief port 13. When the pump 520 works normally, the valve 21 is fixed in the pressure relief port 13 through the cooperation of the poppet value and the pressure relief port 13. When the nozzle 400 is blocked and the hydraulic pressure in the pump body 1 exceeds the preset pressure threshold, the pesticide in the pump body 1 will hold the poppet value. When the holding force of the pesticide overcomes the elastic restoring force, the valve 21 may be pushed open and separated from the pressure relief port 13.

In order to better realize the overpressure protection, the valve 21 in this embodiment may be made of flexible materials, such as rubber, plastic, and the like. With the flexible valve 21, when the hydraulic pressure in the pump body 1 exceeds the preset pressure threshold, the pesticide in the pump body 1 can easily open the valve 21 to realize the pressure relief protection function.

In some embodiments, the elastic reset member 22 may be connected to the surface of the valve 21 facing away from the pressure relief port 13. In some embodiments, the elastic reset member 22 may be integrally formed on the valve 21. In some embodiments, a fixed end may be disposed on the surface of the valve 21 facing away from the pressure relief port 13, and the elastic reset member 22 may be fixedly connected to the fixed end. The connection method of the elastic reset member 22 and the fixed end may adopt any connection methods. For example, the elastic reset member 22 may be sleeved and matched with the fixed end.

In order to make the elastic reset member 22 apply different magnitudes of elastic restoring force to the valve 21, in conjunction with FIG. 2 and FIG. 3, the pressure relief device 2 further includes a cover 23. The cover 23 may be fixedly connected to the pump body 1, and the elastic reset member 22 and the cover 23 may be movable connected. When the elastic reset member 22 moves to different positions relative to the cover 23, the elastic reset member 22 can apply different magnitudes of elastic restoring force to the valve 21, and the valve 21 can seal the pressure relief port 13 under the action of the elastic restoring force exerted by the elastic reset member 22. By adjusting the elastic restoring force applied by the elastic reset member 22 to the value 21, the preset pressure threshold can be adjusted to meet different pressure protection needs.

In this embodiment, the cover 23 is disposed at the pressure relief port 13. The cover 23 and the pump body 1 surround to form a receiving space. The valve 21 may be disposed in the receiving space, and the valve 21 may be fixedly connected to the inner side wall of the cover 23. By disposing the valve 21 in the receiving space, the valve 21 can be prevented from being separated from the pressure relief port 13 and lost when the pressure is relieved.

The fixed connection method between the cover 23 and the pump body 1 can be any fixed connection methods. In some embodiments, referring to FIG. 2 and FIG. 3, the cover 23 and the pump body 1 are fixedly connected by a fixing member 27 (such as a bolt).

In some embodiments, the cover 23 may include a first opening, and the elastic reset member 22 may directly or indirectly cooperate with the first opening to apply elastic restoring force of different magnitudes to the valve 21. In some embodiments, the elastic reset member 22 may be connected to the side of the valve 21 facing away from the pressure relief port 13, and the first opening may be positioned at a predetermined distance from the side of the valve 21 facing away from the pressure relief port 13. The first opening may be a round hole or a hole of other shapes. In this embodiment, the first opening is a round hole as an example.

The application of the elastic restoring force of different magnitudes to the valve 21 by the elastic reset member 22 may be implemented based on different structures. For example, in one embodiment, the elastic reset member 22 may be movably inserted into the first opening. When the elastic reset member 22 moves to a different position relative to the first opening in the first opening, the elastic reset member 22 may apply different elastic restoring forces to the valve 21. In some embodiments, the elastic reset member 22 may be squeezed in the first opening. By pressing one end of the elastic reset member 22 away from the valve 21, the elastic reset member 22 may be gradually compressed, and the elastic restoring force exerted by the elastic reset member 22 on the valve 21 may be come larger and larger, and the holding force needed for the pesticide to push the valve 21 may also become larger. By pulling the end of the elastic reset member 22 away from the valve 21, the elastic reset member 22 may be gradually stretched, but the valve 21 may not be separated from the pressure relief port 13, and the holding force needed for the pesticide to push the valve 21 may become smaller. In order to meet the needs of different pumps 520 for overpressure protection (the maximum hydraulic pressure that different pumps 520 can withstand may be different), the position of the elastic reset member 22 in the first opening may be moved as needed. In some embodiments, the elastic reset member 22 may be made of flexible materials, such as rubber, plastic, and other flexible materials.

In another implementation, referring to FIG. 2 and FIG. 3, the pressure relief device 2 further includes an adjusting member 24. The adjusting member 24 may cooperate with the elastic reset member 22 to adjust the magnitude of the elastic restoring force, such that the elastic reset member 22 can apply different magnitudes of elastic restoring force to the valve 21. In this embodiment, one end of the elastic reset member 22 is connected to the valve 21, the other end is connected to the adjusting member 24, and the adjusting member 24 may be rotatably inserted into the first opening. When the adjusting member 24 rotates relative to the first opening in the first opening, the adjusting member 24 may drive the elastic reset member 22 to expand and contract to adjust the elastic restoring force. More specifically, when the adjusting member 24 rotates in a first direction in the first opening, the adjusting member 24 may move toward the valve 21, such that the elastic reset member 22 may be gradually compressed, the elastic restoring force exerted by the elastic reset member 22 to the valve 21 may become larger and larger, and the holding force needed by the pesticide to push the valve 21 may also become larger. When the adjusting member 24 rotates in a second direction in the first opening 5111, the adjusting member 24 may move away from the valve 21, such that the elastic reset member 22 may be gradually stretched, but the valve 21 may not be separated from the pressure relief port 13, the elastic restoring force applied by the elastic reset member 22 may become smaller and smaller, and the holding force needed for the pesticide to push the valve 21 may also become smaller. The first direction may be different from the second direction. In some embodiments, the first direction may be a clockwise direction, and the second direction may be a counterclockwise direction. In order to meet the needs of different pumps 520 for overpressure protection (the maximum hydraulic pressure that different pumps 520 can withstand may be different), the adjusting member 24 may be rotated as needed.

The type of elastic reset member 22 may be selected based on needs. In some embodiments, the elastic reset member 22 may be made of flexible materials, such as rubber, plastic, etc. In some embodiments, the elastic reset member 22 may be a spring. The type of the adjusting member 24 may also be selected based on needs. In some embodiments, the adjusting member 24 may be a threaded piece, such as a screw, and the threaded piece may be connected to the first opening through a threaded rotation. In this embodiment, the elastic reset member 22 is a spring, and the adjusting member 24 is a screw. One end of the spring is sleeved on the fixed end, and the other end is sleeved on the screw.

In addition, in order for the user to conveniently adjust the expansion and contraction of the elastic reset member 22, a part of the adjusting member 24 may penetrate the first opening and may be exposed outside the first opening for the user to make adjustment.

Referring to FIG. 2 and FIG. 3, the pressure relief device 2 further includes a travel switch 25. The elastic reset member 22 may abut against one end of the valve 21, and the travel switch 25 may abut against the other end of the valve 21, such that the structural distribution of the pressure relief device 2 can be more reasonable and compact. In this embodiment, both the elastic reset member 22 and the travel switch 25 abut against the surface of the valve 21 facing away from the pressure relief port 13. When the nozzle 400 is blocked and the hydraulic pressure in the pump body 1 exceeds the preset pressure threshold, the pesticide in the pump body 1 may open the valve 21 to separate the valve 21 from the pressure relief port 13. The valve 21 may push the travel switch 25 to move. The travel switch 25 may detect the movement of the valve 21 in time, thereby transmitting an overpressure signal to ten end back (e.g., the control center).

In some embodiments, the cover 23 may include a second opening. The travel switch 25 may be inserted into the second opening, and the travel switch 25 may be fixed through the second opening to prevent the travel switch 25 from being lost. In some embodiments, the travel switch 25 may be movably inserted into the second opening.

Referring to FIG. 2 and FIG. 3, the pressure relief device 2 further includes an auxiliary member 26. The auxiliary member 26 may be disposed on the surface of the valve 21 facing away from the pressure relief port 13. The travel switch 25 and the elastic reset member 22 may abut against the valve 21 through the auxiliary member 26. By using the auxiliary member 26, the flexible valve 21 can better seal the pressure relief port 13, and when the valve 21 is separated from the pressure relief port 13, the movement of the valve 21 may be transmitted to the travel switch 25 in time.

In some embodiments, a third opening may be disposed on the auxiliary member 26, and the elastic reset member 22 may abut against the valve 21 through the auxiliary member 26 in different ways. For example, in some embodiments, the elastic reset member 22 may be connected with the valve 21 through the third opening. In other embodiments, a part (fixed end( ) of the valve 21 may be connected to the elastic reset member 22 through the third opening.

The travel switch 25 may also abut against the valve 21 through the auxiliary member 26 in different ways. In some embodiments, the auxiliary member 26 may be fixedly connected to the surface of the valve 21 facing away from the pressure relief port 13. For example, the auxiliary member 26 may be fixedly connected to the surface of the valve 21 facing away from the pressure relief port 13 by bonding, clamping, or other methods. In some embodiments, the auxiliary member 26 may be disposed in the receiving space surrounded by the cover 23 and the pump body 1, and the auxiliary member 26 may be movably connected to the inner side wall of the cover 23.

In some embodiments, the auxiliary member 26 may be a rigid part, such as a stainless steel part. In some embodiments, the auxiliary member 26 may have a rigid sheet-like structure. The auxiliary member 26 of the rigid sheet-like structure can not only enable the flexible valve 21 to better seal the pressure relief port 13 without adding too much weight to the pressure relief device 2, but can also transmit the movement of the valve 21 to the travel switch 25 in time when the valve 21 is separated from the pressure relief port 13.

The agricultural plant protection machine in the embodiments of the present disclosure may be a plant protection unmanned aerial vehicle (UAV), a pesticide spraying vehicle, a manual spraying device, etc., and the pump 520 may be applied to the agricultural plant protection machine. When the nozzle of the agricultural plant protection machine is blocked and the hydraulic pressure in the pump body is too large, the pump 520 can be effectively protected through the timely pressure relief of the pressure relief device, and the service life of the pump 520 can be prolonged.

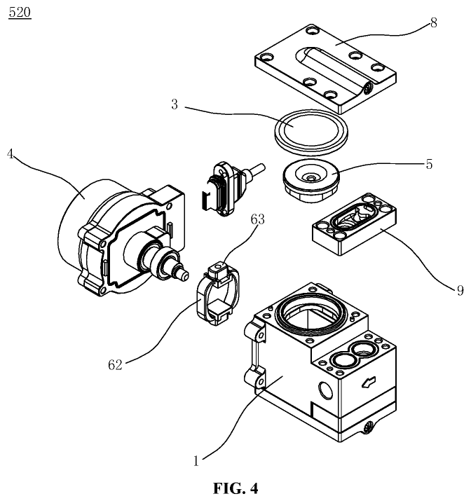

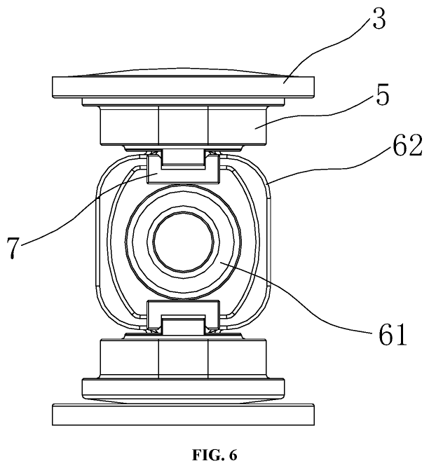

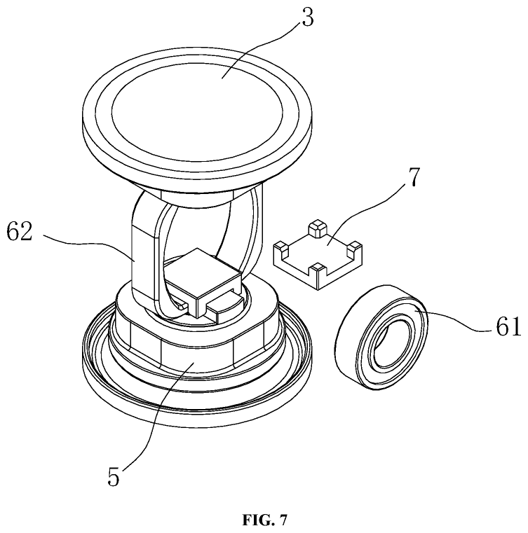

In some embodiments, the pump 520 may be a diaphragm pump of other types of pumps. In this embodiment, the pump 520 is a diaphragm pump. Referring to FIG. 4 to FIG. 8, the diaphragm pump includes a pump body 1, a pump cover 8, a diaphragm 3, a driving mechanism 4, and a diaphragm support 5. In some embodiments, the pump cover 8 may be disposed on the pump body 1, and the diaphragm 3 may be disposed in the pump body 1. In this embodiment, the diaphragm 3 can cooperate with the pump cover 8. More specifically, the diaphragm 3 and the pump cover 8 are connected to form a cavity. The driving mechanism 4 is connected to the diaphragm 3. In this embodiment, the driving mechanism 4 may be directly or indirectly connected to the side of the diaphragm 3 away from the cavity. The driving mechanism 4 may be used to drive the diaphragm 3 to reciprocate relative to the pump cover 8, such that the cavity can be reduced or enlarged. When the driving mechanism 4 drives the diaphragm 3 to move toward the pump cover 8, that is, when the driving mechanism 4 squeezes the diaphragm 3, the size of the cavity can be reduced, and the pesticide in the cavity can be discharged. When the driving mechanism 4 drives the diaphragm 3 to move away from the pump cover 8, that is, when the driving mechanism 4 stretches the diaphragm 3, the size of the cavity can be increased, and the pesticide can be sucked into the cavity from the outside.

In this embodiment, one end of the diaphragm support 5 abuts against the side of the diaphragm 3 away from the pump cover 8, and the other end is connected to the driving mechanism 4. In addition, the contact area between the diaphragm support 5 and the diaphragm 3 on the side sway from the pump cover 8 (hereinafter referred to as the abutting surface in the following embodiments) is greater than a predetermined area threshold. By abutting the diaphragm support 5 on the side of the diaphragm 3 away from the cavity, and designing the area of the contact surface between the diaphragm support 5 and the side of the diaphragm 3 away from the cavity to be large enough, when the driving mechanism 4 drives the diaphragm 3 to move relative to the pump cover 8, the diaphragm 3 can be restricted by the diaphragm support 5, such that the diaphragm 3 can reciprocate in the same direction, and the movement of the diaphragm 3 in other directions can be reduce, thereby improving the stress condition of the diaphragm 3, and extending the service life of the diaphragm 3. When the driving mechanism 4 drives the diaphragm 3 to move toward the pump cover 8, due to the abutment of the diaphragm support 5, the diaphragm 3 can be fully lifted up and have a sufficient amount of deformation, thereby ensuring the size change of the cavity and ensuring that the pesticide in the cavity can be completely discharged.

In some embodiments, the diaphragm 3 may include a connecting part and a supporting part positioned at the outer edge of the connecting part. The connecting part may be driven to move by the driving mechanism 4, and the supporting part may be disposed on the corresponding pump cover 8. The outer edge of the supporting part may be respectively disposed on the pump cover 8 by clamping or other means. In some embodiments, the thickness of the connecting part may be greater than the thickness of the other parts of the diaphragm 3. Since the connecting is driven by the driving mechanism 4 to move, the thickness of the connecting part may be designed to be thicker. Even if the connecting part is worn, the movement of the connecting part driven by the driving mechanism 4 may not be affected. In some embodiments, the thickness may refer to the thickness of the diaphragm 3 in its moving direction.

In this embodiment, the diaphragm 3 has a circular shape. Of course, in other embodiment, the diaphragm 3 may also have other regular or irregular shapes.

The predetermined area threshold may be embodied in the form of a ratio (the ratio of the contact area between the diaphragm support 5 and the abutting surface to the surface area of the abutting surface), or it may be embodied by the size of the area. In this embodiment, the ratio of the contact area between the diaphragm support 5 and the abutting surface to the surface area of the abutting surface may be greater than or equal to 80%, such as 85%, 90%, 95%, or 100%.

The predetermined area threshold may be designed based on the displacement requirements of the diaphragm pump. For example, in one embodiment, the ratio of the contact area between the diaphragm support 5 and the abutting surface to the surface area of the abutting surface may be greater than or equal to 100%, that is, the diaphragm support 5 may cove the contact surface. When the driving mechanism 4 squeezes the diaphragm 3, under the squeezing action of the diaphragm support 5, the surface of the diaphragm 3 facing away from the abutting surface can fit the pump cover 8 as much as possible, and the size of the cavity can be small enough to exhaust the pesticides in the cavity as much as possible. In this embodiment, the area of the surface of the diaphragm support 5 facing the diaphragm 3 may be equal to the area of the contact surface, or the area of the surface of the diaphragm support 5 facing the diaphragm 3 may be slightly larger than the area of the contact surface, thereby ensuring that the diaphragm support 5 can cover the contact surface of the diaphragm 3. In another embodiment, the ratio of the contact area between the diaphragm support 5 and the abutting surface to the surface of the abutting surface may be greater than the predetermined area ratio threshold and less than 100%, and the diaphragm support 5 may not completely cover the abutting surface.

In order to better restrict the diaphragm 3, ensure that the diaphragm 3 can be fully lifted, and ensure that the diaphragm 3 has sufficient deformation, in some embodiments, the stiffness of the diaphragm support 5 may be greater than a predetermined stiffness threshold. In some embodiments, the predetermined stiffness threshold may be set as needed, such as 10 N/m. In some embodiments, the diaphragm support 5 may be a rigid part.

In addition, in order to reduce the wear of the diaphragm support 5 on the diaphragm 3 during the reciprocating movement, in some embodiment, the diaphragm support 5 may abut against the side of the diaphragm 3 away from the pump cover 8 through a curved surface.

The diaphragm pump may be a single diaphragm pump or a double diaphragm pump. The following embodiments will specifically describe the structure of a single diaphragm pump and a double diaphragm pump. In the following examples, when describing the structure of the single diaphragm pump and the double diaphragm pump, the application of the diaphragm pump to the plant protection UAV is taken as an example. In some embodiments, the plant protection UAV may include a pipeline 300, a liquid storage tank 200, and a nozzle 400.

In one embodiment, the diaphragm pump may be a single diaphragm pump, and there may be one pump cover 8 and one diaphragm 3. The driving mechanism 4 may squeeze the diaphragm 3 and the driving mechanism 4 may stretch the diaphragm 3 to form a movement cycle. In this embodiment, the liquid inlet 11 and the liquid outlet 12 of the single diaphragm pump may be respectively connected with the cavity, the liquid inlet 11 may be connected to the liquid storage tank 200 through the pipeline 300, and the liquid outlet 12 may be connected to the nozzle 400 through the pipeline 300.

The process of the single diaphragm pump controlling the flow of pesticides may be as follow. When the cavity reduces, the cavity may be connected with the pipeline 300 through the liquid outlet 12, the liquid inlet 11 may be close, the pesticides in the cavity (the pesticide cued by the cavity in the first half of the movement cycle at the current time) may be discharged to the nozzle 400 through the liquid outlet 12, and the nozzle 400 may spray the pesticides to the designed area (farmland, woods, etc.). When the cavity enlarges, the cavity may be directly or indirectly connected with the liquid storage tank 200 through the liquid inlet 11, the liquid outlet 12 may be closed, and the pesticides in the liquid storage tank 200 may enter the cavity trough the liquid inlet 11.

The liquid inlet 11 and the liquid outlet 12 may be disposed on the same side of the pump cover 8, making the structure of the single diaphragm pump more compact, which is advantageous to the miniaturization design of the single diaphragm pump. The single diaphragm pump has the advantages of small size, light weight, and low power consumption, and will not affect the plant protection UAV equipped with it.

In another embodiment, the diaphragm pump may be a double diaphragm pump, and there may be two pump covers 8 and two diaphragms 3. The two pump covers 8 may correspondingly cooperate with the two diaphragms 3. The two pump covers 8 may be respectively disposed on both sides of the pump body 1, and the two diaphragms 3 may be respectively disposed on the corresponding pump cover 8. The cavity may include a first cavity and a second cavity formed by the two diaphragms 3 and the corresponding pump cover 8. In this embodiment, the driving mechanism 4 may drive the tow diaphragms 3 to move closer to or farther away from the corresponding pump cover 8, such that the sizes of the first cavity and the second cavity can change in opposite directions.

Specifically, the pump cover 8 may include a first pump cover and a second pump cover, the diaphragm 3 may include a first diaphragm and a second diaphragm. The first diaphragm may cooperate with the first pump cover, and the second diaphragm may cooperate with the second pump cover. In this embodiment, the first diaphragm and the second diaphragm may move in opposite directions. When the driving mechanism 4 squeezes the first diaphragm and stretches the second diaphragm, the first diaphragm may move closer to the first pump cover, and the second diaphragm 3 may move away from the second pump cover, such that the first cavity can be reduced and the second cavity can be enlarged. When the driving mechanism 4 stretches the first diaphragm and squeezes the second diaphragm, the first diaphragm may move away from the first pump cover, and the second diaphragm may move closer to the second pump cover, such that the first cavity can be enlarged and the second cavity can be reduced. In this embodiment, the two processes of the driving mechanism 4 squeezing the first diaphragm and stretching the second diaphragm, and the driving mechanism 4 stretching the first diaphragm 3 and squeezing the second diaphragm form a movement cycle.

Further, the liquid inlet 11 may include a first liquid inlet connected with the first cavity and a second liquid inlet connected with the second cavity, and the liquid outlet 12 may include a first liquid outlet connected with the first cavity and a second liquid outlet connected with the second cavity. The first liquid inlet, the second liquid inlet, the first liquid outlet, and the second liquid outlet may be connected to the pipeline 300, such that the liquid flow direction of the pipeline 300 can be controlled by controlling the opening and closing of the first liquid inlet, the second liquid inlet, the first liquid outlet, and the second liquid outlet.

The process of the double diaphragm pump controlling the flow of pesticides may be as follow. When the first cavity reduces and the second cavity enlarges, the first liquid inlet and the second liquid inlet may be connected with the pipeline 300, and the first liquid inlet and the second liquid inlet may be closed. The first liquid outlet and the second liquid inlet may be opened under the flow of the liquid pesticide, and the first liquid inlet and the second liquid outlet may be closed under the flow of the liquid pesticide. In some embodiments, the first cavity may discharge the liquid pesticide in first cavity (the liquid pesticide sucked by the first cavity in the first half of the movement cycle of the current time) to the nozzle 400 through the first liquid outlet and the pipeline 300, and the nozzle 400 may spray the liquid pesticide to the designated area (farmland, woods, etc.). At the same time, the second cavity may suck the liquid pesticide from the liquid storage tank 200 through the second liquid inlet and the pipeline 300, and store it in the second cavity. Since the first liquid inlet and the second liquid outlet are closed, the first cavity may not suck liquid pesticide from the liquid storage tank 200 through the first liquid inlet and the pipeline 300, and the second cavity may not discharge the liquid pesticide in the second cavity through the second liquid outlet and the pipeline 300.

When the first cavity enlarges and the second cavity shrinks, the first liquid inlet and the second liquid outlet may be connected with the pipeline 300, and the first liquid outlet and the second liquid inlet may be closed. The first liquid inlet and the second liquid outlet may be opened under the action of the flow of the liquid pesticide, and the first liquid outlet and the second liquid inlet may be closed under the action of the flow of the liquid pesticide. In some embodiments, the second cavity may discharge the liquid pesticide in the second cavity (the liquid pesticide sucked by the second cavity in the first half of the movement cycle at the current time) through the second liquid outlet and the pipeline 300 to the nozzle 400, and the nozzle 400 may spray the liquid pesticide to the designated area. At the same time, the first cavity may such the liquid pesticide from the liquid storage tank 200 through the first liquid inlet and the pipeline 300, and store it in the first cavity. Since the first liquid outlet and the second liquid inlet are closed, the first cavity may not discharge the liquid pesticide in the first cavity through the first liquid outlet and the pipeline 300, and the second cavity may not suck the liquid pesticide from the liquid storage tank 200 through the second liquid inlet and the pipeline 300.

In this embodiment, the two diaphragms 3 may be respectively disposed on the corresponding pump cover 8 to form two cavities, which have strong corrosion resistance, and the design of the two cavities can increase the flow and pressure of the diaphragm pump.

In some embodiments, the first liquid inlet and the first liquid outlet, and the second liquid inlet and the second liquid outlet may be respectively disposed on the same side of the corresponding pump cover 8. By disposing the liquid inlet 11 and the liquid outlet 12 on the same side of the corresponding pump cover 8, the structure of the double diaphragm pump can be more compact, which is advantageous to the miniaturization design of the double diaphragm pump. The double diaphragm pump has the advantages of small size, light weight, and low power consumption, and will not affect the plant protection UAV equipped with it.

The driving mechanism 4 may directly or indirectly drive the diaphragm 3 to reciprocate. For example, in one embodiment, the driving mechanism 4 and the side of the diaphragm 3 away from the pump cover 8 may be directly connected by a hinge, and the driving mechanism 4 may drive the diaphragm 3 to be closer or farther away.

In another embodiment, the diaphragm pump may also include a transmission mechanism 6. The driving mechanism 4 may be connected to the diaphragm 3 through the transmission mechanism 6, and the driving mechanism 4 may also be connected to the diaphragm support 5 through the transmission mechanism 6. In some embodiments, the transmission mechanism 6 may be respectively connected with the driving mechanism 4 and the diaphragm support 5. The driving mechanism 4 may rotate to drive the transmission mechanism 6 to push the diaphragm support 5 and the diaphragm 3 to move back and forth relative to the pump cover 8 at the same time to change the size of the cavity. More specifically, the driving mechanism 4 may rotate in the first direction, driving the transmission mechanism 6 to push the diaphragm support 5 and the diaphragm 3 closer relative to the pump cover 8 at the same time, and the cavity may gradually decrease. Further, the driving mechanism 4 may rotate in the second direction, driving the transmission mechanism 6 to push the diaphragm support 5 and the diaphragm 3 away from the pump cover 8 at the same time, and the cavity may gradually increase.

The transmission mechanism 6 may be an eccentric rotation structure, a gear structure, or a linkage mechanism. In some embodiments, the transmission mechanism 6 may include an eccentric rotating member 61. In some embodiments, the driving mechanism 4 may be connected to the eccentric rotating member 61. The driving mechanism 4 may rotate to drive the eccentric rotating member 61 to rotate, and the eccentric rotating member 61 may push against the diaphragm 3 to move.

The following description takes the diaphragm pump as a double diaphragm pump as an example to further explain the eccentric rotating member 61.

The driving mechanism 4 may be connected with the eccentric rotating member 61, the driving mechanism 4 may rotate to drive the eccentric rotating member 61 to rotate, and the eccentric rotating member 61 may push the two diaphragms 3 to move. In some embodiments, the eccentric rotating member 61 may be disposed in the pump body 1 and positioned between a first diaphragm and a second diaphragm, and the two sides of the eccentric rotating member 61 may be movably abutting against the first diaphragm and the second diaphragm, respectively. In some embodiments, the eccentric rotating member 61 may convert the rotational force of the driving mechanism 4 into a push-pull force. As the eccentric rotating member 61 rotates to different positions, the distance between the eccentric rotating member 61 and the first diaphragm (the distance from the eccentric position of the eccentric rotating member 61 to the first diaphragm) and the distance between the eccentric rotating member 61 and the second diaphragm (the distance from the eccentric position of the eccentric rotating member 61 to the second diaphragm) may change in opposite directions. When the distance between the eccentric rotating member 61 and the first diaphragm gradually increases and the distance between the second diaphragm gradually decreases, the pushing and pulling force of the eccentric rotating member 61 may squeeze the first diaphragm and pull the second diaphragm such that the first cavity can be reduced, and second cavity can be enlarged. When the distance between the eccentric rotating member 61 and the first diaphragm gradually decreases and the distance between the second diaphragm gradually increases, the pushing and pulling force of the eccentric rotating member 61 may pull the first diaphragm and squeeze the second diaphragm such that the first cavity can be enlarged, and second cavity can be reduced.

The eccentric rotating member 61 may directly or indirectly abut against the first diaphragm and the second diaphragm. For example, in one embodiment, the two sides of the eccentric rotating member 61 may directly abut against the first diaphragm and the second diaphragm, respectively.

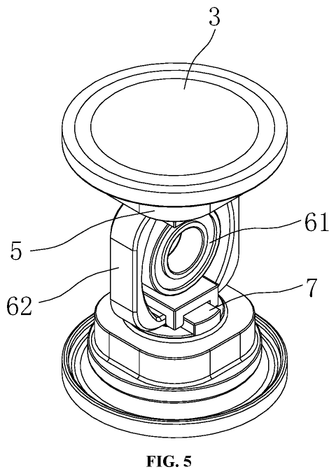

In another embodiment, referring to FIG. 5 and FIG. 8, the eccentric rotating member 61 indirectly abuts against the first diaphragm and the second diaphragm. The transmission mechanism 6 further include a bracket 62 and a connecting part 63 disposed on both sides of the bracket 62. The eccentric rotating member 61 inserted into the bracket 62. The two diaphragms 3 are respectively positioned on both sides of the bracket 62 and connected with the connecting part 63 on the corresponding side. The eccentric rotating member 61 may rotate to drive the bracket 62 and the connecting part 63 to move against the diaphragm support 5 and the diaphragm 3. In this embodiment, through the cooperation of the bracket 62 and the connecting part 63, the rotary motion of the eccentric rotating member 61 can be converted into the unidirectional reciprocating motion of the diaphragm support 5 and the diaphragm 3, thereby realizing the pesticide pumping function.

In this embodiment, the bracket 62 may include a receiving space (not shown in the accompanying drawings), and the eccentric rotating member 61 may be disposed in the receiving space and abut against the bracket 62. By using the bracket 62, the wear of the first diaphragm and the second diaphragm caused by the direct contact between the eccentric rotating member 61 and the first diaphragm and the second diaphragm can be reduced.

Further, in order to prevent the structural wear of the eccentric rotating member 61 and the bracket 62 caused by the relative rotation of the eccentric rotating member 61 and the bracket 62, a gasket may be disposed at the junction of the eccentric rotating member 61 and the bracket 62. The material of the gasket 7 is not specifically limited herein, and the gasket 7 may be made of conventional wear-resistance materials. In some embodiments, the circumferential side walls of the eccentric rotating member 61 may abut against the inner side wall of the bracket 62, and the gasket 7 may be an anti-wear washer. In some embodiments, referring to FIG. 8, a part of the eccentric rotating member 61 is in contact with the inner side wall of the bracket 62, and the gasket 7 is a one-piece structural member, which can reduce the cost and the size requirements of the eccentric rotating member 61 and the bracket 62.

In some embodiments, the eccentric rotating member 61 may be an eccentric wheel, an eccentric bearing, or other eccentric rotating structure. More specifically, the type of the eccentric rotating member 61 may be selected as needed.

In some embodiments, the connecting part 63 may be integrally formed on the outer side wall of the bracket 62. In other embodiments, the connecting part 63 and the bracket 62 may be separately arranged. In some embodiments, the bracket 62 may include an insertion groove, and the connecting part 63 may be inserted into the insertion groove. In some embodiments, the connecting part 63 may be a screw or other structural parts.

In addition, the fixing method between the diaphragm support 5 and the connecting part 63 may adopt any conventional fixing method. In some embodiments, the diaphragm support 5 may be sleeved and fixed on the connecting part 63. In other embodiments, the diaphragm support 5 may also be fixed on the connecting part 63 by means of screw threads, clamping connections, or the like.

In some embodiments, the driving mechanism 4 may include a motor, and the main shaft of the motor may extend into the pump body 1 and may be connected with the transmission mechanism 6, thereby transmitting the driving force from the transmission mechanism 6 to the diaphragm 3 to drive the diaphragm 3 to move. Take the eccentric rotating member 61 as an eccentric wheel as an example, the cooperation of the motor and the transmission mechanism 6 will be described below. In some embodiments, the main shaft may pass through the eccentric wheel and the bracket 62. In addition, the main shaft may be fixed to the bottom of the bracket 62 by a fixing block. Further, the diaphragm pump may include a protective cover. The protective cover may fix the motor cover on one side of the pump body 1, thereby fixing and protecting the motor.

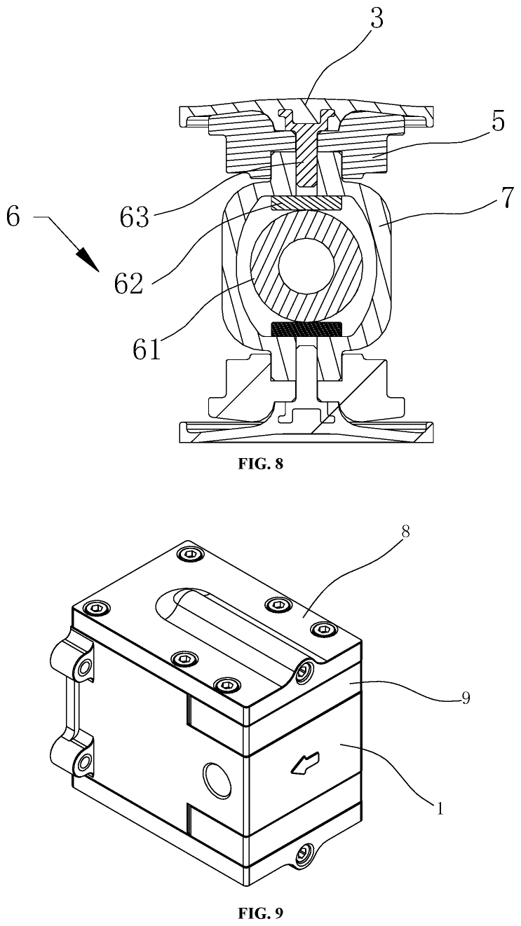

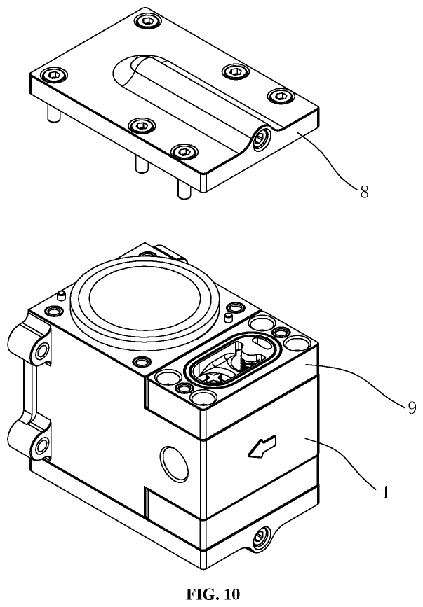

Referring to FIG. 9 to FIG. 12, the diaphragm pump further includes a first check valve 10, a second check valve 20, and a valve cover 9. In some embodiments, the liquid inlet 11 and the liquid outlet 12 may be respectively connected with the cavity. The first check valve 10 may be used to control the opening and closing of the liquid inlet 11, and the second check valve 20 may be used to control the opening and closing of the liquid outlet 12. The valve cover 9 may be used to fix the first check valve 10 and the second check valve 20, such that the first check valve 10 and the second check valve 20 can be integrated through the valve cover 9.

In some embodiments, the valve cover 9 may be detachably connected to the pump body 1 to fix the first check valve 10 and the second check valve 20 on the pump body 1, thereby integrating the first check valve 10 and the second check valve 20 into the pump body 1. Compared with the method of the fixing the check valve of the conventional diaphragm pump on the diaphragm 3 through the valve seat, the first check valve 10 and the second check valve 20 can be integrated into the pump body 1 through the valve cover 9. Therefore, after the diaphragm 3 is removed, the first check valve 10 and the second check valve 20 may still be integrated into the pump body 1 through the valve cover 9 without being affected by the removal of the diaphragm 3. In addition, the valve cover 9 and the pump cover 8 may be separately arranged. After the pump cover 8 is disassembled, the first check valve 10 and the second check valve 20 may still be fixed on the valve cover 9 and may not be affected by the removal of the pump cover 8.

Consistent with the present disclosure, a valve cover 9 that is independent of the pump cover 8 can be added to the diaphragm pump, and integrate two check valves (the first check valve 10 and the second check valve 20) on the valve cover 9. Further, through the detachable connection of the valve cover 9 and the pump body 1, the two check valves may be integrated into the pump body 1. The two check valves may not be affected by the removal of the pump cover 8 and the diaphragm 3, thereby avoiding the risk of losing the check valve. In addition, by using the valve cover 9 to fix the two check valves, there is no need to separately design a valve seat for each check valve, thereby reducing the number of parts and saving the manufacturing and installation costs.

In some embodiments, the first check valve 10 may include a first valve core 101 and a first elastic member 102. The first valve core 101 may cooperated with the first elastic member 102. The first valve core 101 may be fixed on the pump body 1, and the first elastic member 102 may be fixed on the valve cover 9. More specifically, one end of the first valve core 101 may be fixedly connected with the first elastic member 102, and the other end may be fixedly connected with the pump body 1, and the end of the first elastic member 102 away from the first valve core 101 may be fixedly connected with the valve cover 9.

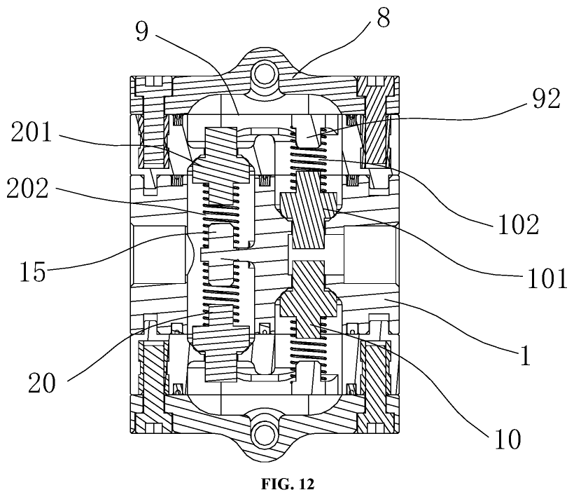

The fixing method of the first valve core 101 and the pump body 1 may be set based on needs. The first valve core 101 may be directly or indirectly fixed on the pump body 1. In one embodiment, the first valve core 101 may be indirectly fixed on the pump body 1 through a valve seat. In another embodiment, referring to FIG. 12, the pump body 1 includes a first groove (not shown in the accompanying drawings), and the first valve core 101 is inserted into the first groove.

The fixing method of the first elastic member 102 and the valve cover 9 may also be set based on needs. Referring to FIG. 12, a first protrusion 92 is disposed on the valve cover 9, and the first elastic member 102 is sleeved and fixed on the first protrusion 92. In some embodiments, the first groove and the first protrusion 92 may be oppositely disposed, making the structure more compact. In this embodiment, the first elastic member 102 is a spring. One end of the spring is sleeved and fixed on the first protrusion 92, and the other end is sleeved and fixed on the first valve core 101. It can be understood that the first elastic member 102 may also be other elastic structures, and the fixing method between the first elastic member 102 and the valve cover 9 is not limited to the fixing method described above.

In some embodiments, the second check valve 20 may include a second valve core 201 and a second elastic member 202. The second valve core 201 may cooperate with the second elastic member 202. The second valve core 201 may be fixed on the valve cover 9, and the second elastic member 202 may be fixed on the pump body 1. More specifically, one end of the second valve core 201 may be fixedly connected with the second elastic member 202, and the other end may be fixedly connected with the valve cover 9, and the end of the second elastic member 202 away from the second valve core 201 may be fixedly connected with the pump body 1.

The fixing method of the second valve core 201 and the valve cover 9 may be set based on needs. The second valve core 201 may be directly or indirectly fixed on the valve cover 9. In one embodiment, the second valve core 201 may be indirectly fixed on valve cover 9 through a valve seat. In another embodiment, referring to FIG. 12, the valve cover 9 includes a second groove (not shown in the accompanying drawings), and the second valve core 201 is inserted into the second groove.

The fixing method of the second elastic member 202 and the pump body 1 may also be set based on needs. Referring to FIG. 12, a second protrusion 15 is disposed on the pump body 1, and the second elastic member 202 is sleeved and fixed on the second protrusion 15. In some embodiments, the second groove and the second protrusion 15 may be oppositely disposed, making the structure more compact. In this embodiment, the second elastic member 202 is a spring. One end of the spring is sleeved and fixed on the second protrusion 15, and the other end is sleeved and fixed on the second valve core 201. It can be understood that the second elastic member 202 may also be other elastic structures, and the fixing method between the second elastic member 202 and the pump body 1 is not limited to the fixing method described above.

In some embodiments, the first protrusion 92 and the second groove may be spaced apart on the valve cover 9. In some embodiments, the valve cover 9 may include a receiving groove, and the first protrusion 92 and the second groove may be both disposed in the receiving groove. In this way, the design of the valve cover 9 is more reasonable and compact.

The valve cover 9 and the pump body 1 may be fixedly connected by any conventional detachable connection method. In some embodiments, referring to FIG. 11, a first fixed connection part 91 is disposed on the valve cover 9, and a second fixed connection part 16 is disposed on the pump body 1 corresponding to the first fixed connection part 91. The first fixed connection part 91 may cooperate with the second fixed connection part 16, such that the valve cover 9 can be detachably connected to the pump body 1. In some embodiments, the first fixed connection part 91 may be a plug-in protrusion, and the second fixed connection part 16 may be a plug-in hole. The plug-in protrusion and the plug-in hole may be connected, such that the valve cover 9 can be detachably connected to the pump body 1. In some embodiments, the first fixed connection part 91 and the second fixed connection part 16 may be snap-fitted.

In order to make the product structure more compact, the valve cover 9 may be positioned between the pump body 1 and the pump cover 8. In one embodiment, the pump cover 8 may be detachably connected with the pump body 1, but may be separated from the valve cover 9 or in contact with the valve cover 9, but not connected. After the diaphragm 3 is damaged, the pump cover 8 may be removed from the pump body 1 to facilitate the maintenance and replacement of the diaphragm 3. Further, after the pump cover 8 is removed, the first check valve 10 and the second check valve 20 may still be fixed to the pump body 1 through the valve cover 9. It can be seen that the removal of the pump cover 8 will not affect the first check valve 10 and the second check valve 20. The connection method between the pump cover 8 and the pump body 1 may be any conventional detachable connection method, such as threaded connection, snap connection, etc.

In another embodiment, the pump cover 8 may be detachably connected to the pump body 1 and the valve cover 9, respectively. After the diaphragm 3 is damaged, the pump cover 8 may be removed from the pump body 1 and the valve cover 9 to facilitate the maintenance and replacement of the diaphragm 3. Further, after the pump cover 8 is removed, the first check valve 10 and the second check valve 20 may still be fixed to the pump body 1 through the valve cover 9. It can be seen that the removal of the pump cover 8 will not affect the first check valve 10 and the second check valve 20. The connection method between the pump cover 8, the pump body 1, and the valve cover 9 may be any conventional detachable connection method, such as threaded connection, snap connection, etc.

In the double diaphragm pump, the first check valve 10 may include a first liquid inlet check valve for controlling the opening and closing of the first liquid inlet, and a second liquid inlet check valve for controlling the opening and closing of the second liquid inlet. The second check valve 20 may include a first liquid outlet check valve for controlling the opening and closing of the first liquid outlet, and a second liquid outlet check valve for controlling the opening and closing of the second liquid outlet. The valve cover 9 may include a first valve cover 9 and a second valve cover 9. The first liquid inlet check valve and the first liquid outlet check valve may be fixed on the first valve cover 9, and the first liquid inlet check valve and the first liquid outlet check valve may be detachably fixed on the pump body 1 through the first valve cover 9. The second liquid inlet check valve and the second liquid outlet check valve may be fixed on the second valve cover 9, and the second liquid inlet check valve and the second liquid outlet check valve may be detachably fixed on the pump body 1 through the second valve cover 9. More specifically, the first valve cover 9 may be detachably connected to the side of the pump body 1 facing the first pump cover to fix the first liquid inlet check valve and the first liquid outlet check valve on the pump body 1. The second valve cover 9 may be detachably connected to the side of the pump body 1 facing the second pump cover to fix the second liquid inlet check valve and the second liquid outlet check valve on the pump body 1.

In some embodiments, the first liquid inlet check valve may be disposed opposite to the second liquid inlet check valve, and the first liquid outlet check valve may be disposed opposite to the second liquid outlet check valve. In this way, the structure of the double diaphragm pump can be more compact, which is convenient for the miniaturized design of the double diaphragm pump.

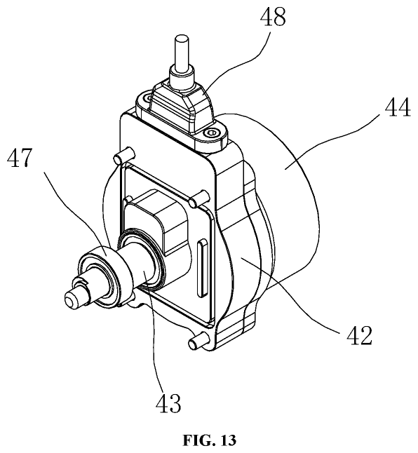

In some embodiments, the driving mechanism 4 may include a motor. Referring to FIG. 13 to FIG. 17, the motor includes a motor body 41, a motor base 42, a motor shaft 43 (i.e., the main shaft), a protective cover 44, a static seal 45, and a dynamic seal 46. The motor body 41 includes a motor rotor 411 and a motor stator 412. The motor base 42 includes a pump body mounting surface 421, a motor mounting surface 422, and a mounting hole 423. In this embodiment, the pump body mounting surface 421 and the motor mounting surface 422 are respectively positioned on opposite sides of the motor base 42, that is, the pump body mounting surface 421 and the motor mounting surface 422 are opposite to each other. Further, mounting hole 423 penetrates the motor mounting surface 422 and the pump body mounting surface 421, and the motor shaft 43 is installed in the mounting hole 423. In some embodiments, the motor shaft 43 may include a connecting end and a power output end. The connecting end may protrude from one end of the mounting hole 423, and the power output end may protrude from the other end of the mounting hole 423. The connecting end may be used for a fixed connection with the motor body 41, and the power output end may be used for outputting power to drive toe diaphragm 3 of the diaphragm pump to reciprocate.

The motor rotor 411 may be fixedly connected to the motor shaft 43, and the motor rotor 411 may be used to drive the motor shaft 43 to rotate. In some embodiments, the motor rotor 411 may rotate, and the motor shaft 43 may rotate synchronously. In some embodiments, the motor shaft 43 and the electronic rotor may rotate asynchronously. Further, motor stator 412 may be used to cooperate with the motor rotor 411. The cooperation method between the electronic state, the motor rotor 411, and the motor shaft 43 may adopt any conventional connection method, which will not be specifically described here.

In some embodiments, the protective cover 44 may be detachably connected to the motor mounting surface 422, and the protective cover 44 and the motor base 42 together may form a receiving cavity. The connecting end of the motor base 42, the motor rotor 411, and the motor stator 412 may all be disposed in the receiving cavity. The receiving cavity may seal the motor rotor 411, the motor stator 412, and other components, thereby protecting the motor rotor 411, the motor stator 412, and the other components. The static seal 45 may be disposed at the connection between the protective cover 44 and the motor base 42. The static seal 45 can realize the static seal between the protective cover 44 and the motor base 42, and prevent liquid from entering the receiving space from the gap between protective cover 44 and the motor base 42. The dynamic seal 46 may be disposed in the mounting hole 423, and one end of the dynamic seal 46 may abut against the outer circumferential surface of the motor shaft 43 near the power output end, and the other end may abut against the inner side wall of the mounting hole 423. The dynamic seal 46 can realize the dynamic seal between the outer circumferential surface of the motor shaft 43 near the power output end and the side wall of the mounting hole 423, and prevent liquid from entering the receiving space from the gap between the outer circumferential surface of the motor shaft 43 near the power output end and the side wall of the mounting hole 423.

Consistent with the present disclosure, by setting the static seal 45 at the connection between the protective cover 44 and the motor base 42, and by setting the dynamic seal 46 at the connection between the motor shaft 43 and the mounting hole 423, a combination of dynamic and static sealing can be adopted to realize the isolation of the motor from the outside world. In this way, liquid can be prevented from entering the motor from the connection between the protective cover 44 and the motor base 42, and the connection between the motor shaft 43 and the mounting hole 423, thereby effectively protecting the motor and improving the service life of the motor.

The protective cover 44 and the motor mounting surface 422 may be detachably connected by snap connection, screw connection, buckle connection, etc. In some embodiments, a first fixed connecting part may be disposed on the motor mounting surface 422, and a second fixed connecting part corresponding to the first fixed connecting part may be disposed on the protective cover 44. The first fixed connecting part may cooperate with the second fixed connecting part, such that the protective cover 44 can be detachably connected to the motor mounting surface 422. In some embodiments, the first fixed connecting part may be a threaded hole, and the second fixed connecting part may be a screw.

The static seal 45 may be a sealing ring or other structure that can achieve static sealing. In this embodiment, the static seal 45 is a sealing ring. In some embodiments, a mounting flange may be disposed at motor mounting surface 422 of the motor base 42, and the sealing may be sleeved and fixed on the mounting flange of the motor base 42. The protective cover 44 may be sleeved and fixed on the mounting flange of the motor base 42, and abut against the sealing ring. By providing a sealing ring, a sealed connection between the protective cover 44 and the mounting flange can be realized. The sealing ring in this embodiment may be a rubber sealing ring or other flexible sealing ring.

The dynamic seal may be a sealing frame or other structures capable of realizing dynamic sealing. In this embodiment, the dynamic seal 46 is a sealing frame, and the sealing frame has an annular shape. The annular-shaped sealing frame can be sleeved on the motor shaft 43, and the outer circumferential surface of the motor shaft 43 near the power output end and the inner side wall of the mounting hole 423 can be sealed and connected by using the annular-shaped sealing frame.

The specific structure of the sealing frame can be designed based on needs. Referring to FIG. 15, in this embodiment, in order to reduce the weight of the sealing frame and reduce the payload impact of the sealing frame on the motor, a first recess 461 is disposed at the side of the sealing frame facing the motor shaft 43, and a first abutting part 462 and a second abutting part 463 are respectively disposed at both sides of the first recess 461. The first abutting part 462 and the second abutting part 463 are distributed along the axial direction of the motor shaft 43. When the sealing frame is sleeved on the motor shaft 43, both the first abutting part 462 and the second abutting part 463 may abut against the outer circumferential surface of the motor shaft 43. By arranging the first recess 461, the weight of the sealing can be reduced. In addition, the first abutting part 462 and the second abutting part 463 positioned on both sides of the first recess 461 can realize the connection between the sealing frame and the outer circumferential surface of the motor shaft 43 at different positions, thereby ensuring the sealed connection between the sealing frame and the outer circumferential surface of the motor shaft 43.

Further, referring to FIG. 15, in order to achieve a tight connection between the sealing frame and the inner side wall of the mounting hole 423, a third abutting part 464 is disposed at the side of the sealing frame away from the motor shaft 43. A stepped part is disposed at the inner side wall of the mounting hole 423, and the third abutting part 464 is abutting against the stepped part. Through the abutting fit of the third abutting part 464 and the stepped part, a sealed connection between the sealing frame and the inner side wall of the mounting hole 423 can be realized.

Further, referring to FIG. 15, in order to reduce the weight of the sealing frame, and to reduce the payload impact of the sealing frame on the motor, a second recess 465 is disposed between the third abutting part 464 and the first abutting part 462 and/or the third abutting part 464 and the first recess 461. In some embodiments, the recess direction of the second recess 465 may face the power output end.

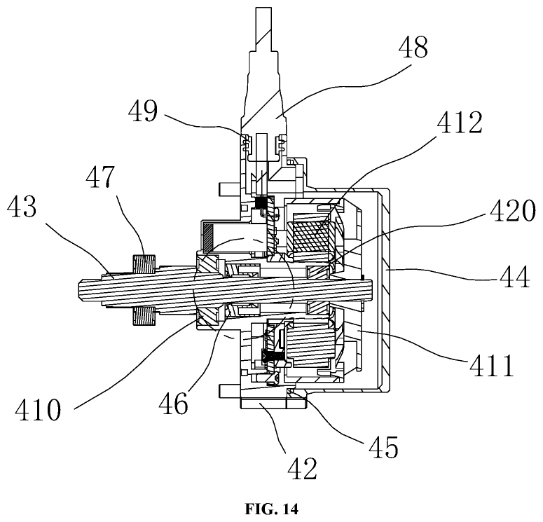

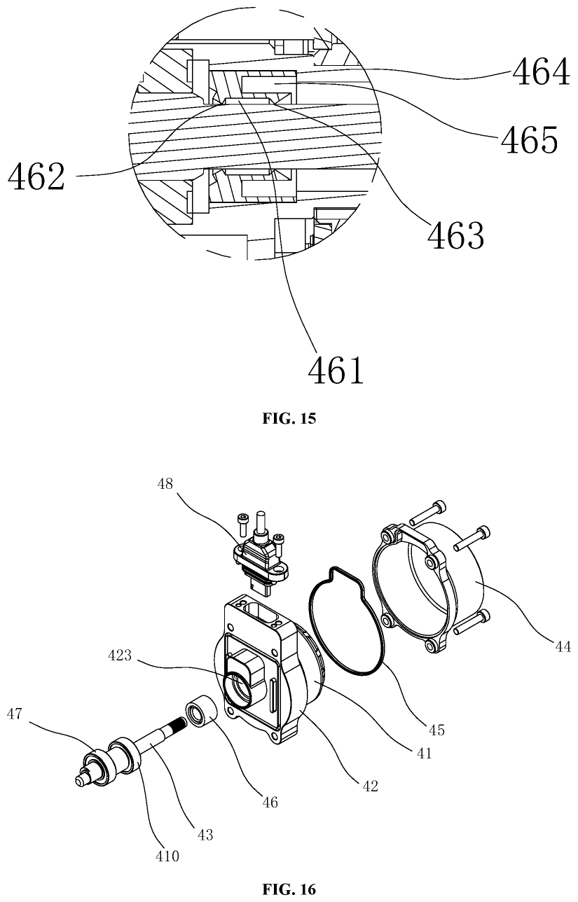

In addition, referring to FIG. 13, FIG. 14, FIG. 16, and FIG. 17, the motor further includes a first bearing 47, and the first bearing 47 is sleeved and fixed on the power output end. The first bearing 47 can be directly connected to the diaphragm 3 or connected to the diaphragm 3 through the transmission mechanism 6 to directly or indirectly transmit the power output from the power output end to the diaphragm 3 to drive the diaphragm 3 to perform reciprocate movement. In this embodiment, the first bearing 47 is exposed outside the motor. In some embodiments, the first bearing 47 may be a waterproof bearing, which is beneficial to the waterproof protection of the first bearing 47.

Referring to FIG. 14, the motor shaft 43 is rotatably inserted into the mounting hole 423 through a second bearing 410. The second bearing 410 is positioned in the mounting hole 423 and is positioned near the power output end, and the dynamic seal 46 is positioned near the second bearing 410.

The motor rotor 411 may be sleeved on the motor shaft 43, and the motor rotor 411 may rotate to drive the motor shaft 43 to rotate. In some embodiments, the motor rotor 411 and the motor shaft 43 may be integrally formed, and the motor rotor 411 may rotate to drive the motor shaft 43 to rotate synchronously. In some embodiments, the motor rotor 411 and the motor shaft 43 may be independent components. The motor rotor 411 may be fixedly sleeved on the motor shaft 43, and the motor shaft 43 may follow the motor rotor 411 to rotate synchronously or non-synchronously.

Referring to FIG. 14, the motor stator 412 is rotatably sleeved on the motor shaft 43 and is positioned in the motor rotor 411. When the motor is working, the motor stator 412 remains stationary. In some embodiments, the motor stator 412 may be rotatably sleeved on the motor shaft 43 through a third bearing 420.

In some embodiments, the motor rotor 411 may include a rotor coil, and the motor stator 412 may include a stator coil. The rotor coil and the stator coil may cooperate to make the motor rotor 411 rotate.

Referring to FIG. 13, FIG. 14, FIG. 16, and FIG. 17, the motor further includes an electrical interface 413 and an electrical plug 48. The electrical interface 413 may be disposed on the motor base 42, and the electrical interface 413 may be electrically connected to the rotor coil and the stator coil. The electrical plug 48 may be detachably electrically connected to the electrical interface 413, and an external power source may be connected through the electrical plug 48 to supply power to the motor. The rotor coil and the state coil may electrically cooperate to cause the motor rotor 411 to rotate.

In some embodiments, the motor may further include a circuit board 414 for controlling the operation of the motor and/or detecting the operating parameters of the motor. The electrical interface 413 may be electrically connected to the rotor coil and the stator coil through the circuit board 414. The circuit board 414 may be disposed in the receiving cavity, and the circuit board 414 may be sleeved on the motor shaft 43. In some embodiments, the circuit board 414 may be positioned between the dynamic seal 46 and the motor stator 412.

In some embodiments, the motor may further include a sealing structure 49, and the sealing structure 49 may be disposed at the inner side wall of the electrical interface 413. When the electrical plug 48 is inserted into the electrical interface 413, the sealing structure 49 can be sleeved on the electrical plug 48. The sealing structure 49 may be a flexible sealing ring, such as a rubber sealing ring. The sealing structure 49 can realize the static sealing of the connection between the electrical interface 413 and the electrical plug 48, and prevent liquid from entering the receiving cavity from the gap between the electrical interface 413 and the electrical plug 48.

The fixed connection method of the sealing structure 49 and the electrical interface 413 may adopt any conventional connection method. In some embodiments, the outer side wall of the sealing structure 49 may include a protrusion, the corresponding position of the electrical interface 413 may include a groove, and the protrusion may cooperate with the groove.

In order to further fix the electrical plug 48, in one embodiment, a third fixed connection part may be disposed at the motor base 42 near the electrical interface 413. A fourth fixed connection part corresponding to the third fixed connection part may be disposed on the electrical plug 48, and the third fixed connection part may cooperate with the fourth fixed connection part, such that the electrical plug 48 and the electrical interface 413 can be detachably connected. In some embodiments, the third fixed connection part may be a threaded hole, and the fourth fixed connection part may be a screw.

After adopting the dynamic seal 46, the static seal 45, and the sealing structure 49, the waterproof level of the motor can reach IP68, which can prevent liquid from entering the motor, effectively protect the motor, and increase the service life of the motor.

In some embodiments, the pressure relief port 13 and the motor may be respectively disposed on opposite sides of the pump body 1 (or other two different sides of the pump body 1) to prevent pesticides from the pressure relief port 13 from entering the motor.

The pump 520 described in the above embodiments can be applied to an airborne spraying system 500. The airborne spraying system 500 can be mounted on an agricultural plant protection machine, such as a plant protection UAV, a pesticide spraying vehicle, or a manual spraying device.

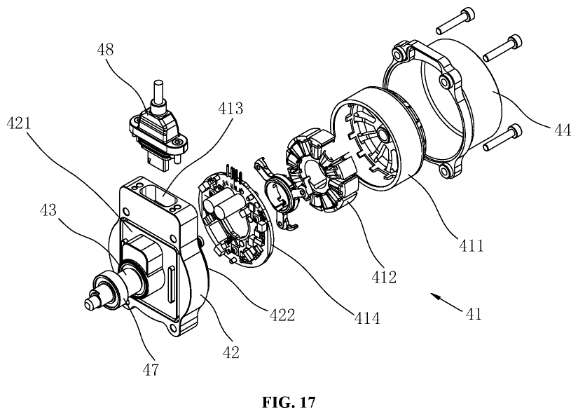

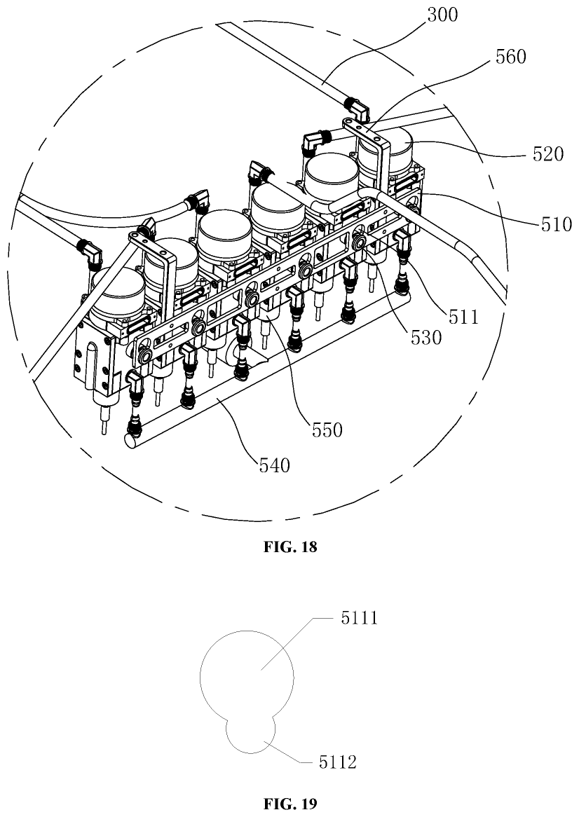

Referring to FIG. 18 to FIG. 20, an embodiment of the present disclosure further provides an airborne spraying system 500. The airborne spraying system 500 includes a fixing frame 510, a pump 520, and a connecting piece 530. The fixing frame 510 includes a plurality of openings 511, each opening 511 includes a first opening 5111 and a second opening 5112 communicating with the first opening 5111. The diameter of the first opening 5111 may be larger than the diameter of the second opening 5112. There may be a plurality of pumps 520 and connecting pieces 530. In some embodiments, the opening 511, the pump 520, and the connecting piece 530 may be in a one-to-one relationship, and the plurality of connecting pieces 530 can be used to fix the plurality of pumps 520 in the corresponding opening 511.

Each connecting piece 530 includes a connecting body 531 and a stop 532. The connecting body 531 may be fixedly connected to the corresponding pump 520, and the stop 532 may be disposed on the connecting body 531. The size of the stop 532 may be greater than the diameter of the second opening 5112, but less than or equal to the diameter of the first opening 5111, such that the stop can pass through the first opening 5111 but cannot pass through the second opening 5112. When the connecting piece 530 cooperates with the opening 511, the stop can pass through the first opening 5111, and the connecting body 531 can slide from the first opening 5111 into the second opening 5112, such that the stop 532 can be blocked by the edge of the second opening 5112, thereby fixing the corresponding pump 520 on the fixing frame 510. It should be noted that in the embodiments of the present disclosure, the size of the stop 532 refers to the size of the stop 532 in a direction perpendicular to the direction in which the stop 532 penetrates the first opening 5111.

Specifically, the process of installing the pump 520 may be as follow. First, the end of the connecting body 531 of the connecting piece 530 away from the stop 532 can be fixedly connected to the pump 520, and the stop 532 can be inserted through the first opening 5111. Slide the connecting body 531 from the first opening 5111 into the second opening 5112, and the stop 532 can be blocked by the edge of the second opening 5112, thereby fixing the corresponding pump 520 on the fixing frame 510.

The process of removing the pump 520 may be as follow. First, slide the connecting body 531 of the connecting piece 530 from the second opening 5112 into the first opening 5111. At this time, the stop 532 can escape from the first opening 5111 toward the direction of the corresponding pump 520, such that the connecting piece 530 can be separated from the opening 511, such that the corresponding pump 520 can be detached from the fixing frame 510.

Consistent with the present disclosure, by arranging the first opening 5111 and the second opening 5112 with different sizes that can communicate with each other on the fixing frame 510, when the pump 520 is installed on the fixing frame 510, the connecting piece 530 can be inserted through the first opening 5111 and slid into the second opening 5112. When removing the pump 520 from the fixing frame 510, the connecting piece 530 can be slid from the second opening 5112 to the first opening 5111, and then the connecting piece 530 can be removed from the first opening 5111. The simple structure and low cost of the cooperation between the connecting piece 530 and the opening 511 can realize the quick installation and removal of the pump 520. The installation and removal process o the pump 520 is simple, with few operation steps, and easy to implement, which saves time for the integration of multiple pumps 520 and facilitates the subsequent repair or replacement of the pump 520 when the pump 520 is damaged.

In some embodiments, the fixing frame 510 may include a fixing plate, and the fixing plate may be a carbon plate. It can be understood that the pump 520 in the airborne spraying system 500 may also be replaced with other types of pumps.

Referring to FIG. 18, a plurality of openings 511 are arranged in a row on the fixing frame 510 at intervals. The arrangement of the plurality of openings 511 can make a plurality of pumps 520 fixed on the fixing frame 510 to be in a row. Even when in use, when one of the pumps 520 is damages and leaks, the leaked liquid (which can be water or liquid pesticide) will not enter other pumps, which is beneficial to the protection of the pumps 520. Of course, the arrangement of the plurality of openings 511 is not limited to this, and other arrangements can also be selected. For example, the plurality of openings 511 can be arranged in a top row and a bottom row, and each row may include one or more pumps 520 arranged at intervals. In some embodiments, the adjacent openings 511 in the top and bottom rows may be staggered to reduce the impact of damage and leakage of the pumps 520 fixed on the top row openings 511 on the pumps 520 fixed on the bottom row openings 511.

In some embodiments, the arrangement direction of the openings 511 arranged at intervals in a row may be referred to as the first direction.

Referring to FIG. 18 and FIG. 19, the first opening 5111 is positioned above the second opening 5112, and the connecting body 531 can be easily slid into the second opening 5112 from the first opening 5111. In some embodiments, the first opening 5111 may be positioned directly above the second opening 5112, and the line connecting the center of the first opening 5111 and the center of the second opening 5112 may be perpendicular to the first direction. In some embodiments, the second opening 5112 may be offset on one side of the first opening 5111 and the second opening 5112 may be positioned below the first opening 5111. The line connecting the center of the first opening 5111 and the center of the second opening 5112 may be inclined relative to the first direction. Of course, in other embodiments, the first opening 5111 and the second opening 5112 may also be arranged along the first direction, and the line connecting the center of the first opening 5111 and the center of the second opening 5112 may be parallel to the first direction.

In addition, the shape of the first opening 5111 and the second opening 5112 may be set based on needs. For example, in one embodiment, the first opening 5111 may be a circular hole, and the second opening 5112 may be a non-circular hole (such as a square hole). In another embodiment, the first opening 5111 may be a non-circular hole (such as a square hole), and the second opening 5112 may be a circular hole. In another embodiment, both the first opening 5111 and the second opening 5112 may be circular holes.

The plurality of connecting pieces 530 may be arranged independently of each other, or the plurality of connecting pieces 530 may be an integral structure. In one embodiment, the plurality of connecting pieces 530 may be arranged independently of each other. Each connecting piece 530 can fix the corresponding pump 520 in the corresponding opening 511, and each pump 520 can be independently installed and removed relative to the fixing frame 510, which is convenient for the subsequent maintenance. In some embodiments, one end of the connecting body 531 of each connecting piece 530 away from the stop 532 may be integrally formed on the housing of the pump 520. In some embodiments, the end of the connecting body 531 of each connecting piece 530 away from the stop 532 may be detachably connected to the housing of the pump 520. For example, the end of the connecting body 531 may be detachably connected to the housing of the pump 520 by means of threaded connection, snap connection, etc.

In another embodiment, referring to FIG. 21, the plurality of connecting pieces 530 are connected by a connecting bracket 533 to form an integral structure. In this embodiment, the connecting bracket 533 is fixedly connected with a plurality of pumps 520. In some embodiments, the connecting bracket 533 can be detachably connected to each pump 520, for example, it can be detachably connected to the housing of the pump 520 by means of threaded connection, clamping connection, etc. In this way, the pump 520 can be separately removed from the connecting bracket 533 to facilitate the subsequent removal and maintenance of the failed pump 520.

In some embodiments, the connecting body 531 may be in interference fit with the second opening 5112. The connecting body 531 may be squeezed into the second opening 5112, and the pump 520 may be relatively firmly fixed on the second opening 5112 through the connecting piece 530, which prevents the pump 520 from shaking due to the unstable connection between the pump 520 and the second opening 5112 during the operation of the airborne spraying system 500.

Of course, in other embodiments, the connecting body 531 and the second opening 5112 may also be in clearance fit, such that the connecting body 531 can be switched between the first opening 5111 and the second opening 5112, thereby facilitating the installation and removal of the pump 520. At this time, in order to reduce the shaking of the pump 520 after being installed in the second opening 5112 through the connecting piece 530, a fixing part can be disposed on the edge of the second opening 5112, and the fixing part can cooperate with the stop 532, thereby stably fixing the pump 520 on the second opening 5112. The fixing part and the stop 532 can cooperate by a snap connection or a plug connection.

In some embodiments, the area of the part of the stop 532 blocked by the edge of the second opening 5112 may be greater than a predetermined area threshold, which further stabilizes the pump 520 on the second opening 5112.

In addition, in one embodiment, the size of the stop 532 may be equal to the diameter of the first opening 5111. The stop 532 can be pulled or pressed with greater force, such that the inner edge of the first opening 5111 can press the stop 532, such that the stop 532 can be deformed and the first opening 5111 can be penetrated. In another embodiment, the size of the stop 532 may be smaller than the diameter of the first opening 5111. In this way, the stop 532 can easily penetrate the first opening 5111, thereby facilitating the installation and removal of the pump 520.

The connecting piece 530 may be made of flexible materials, such as rubber or plastic, thereby reducing the vibration of the pump 520 during operation or during transportation.

In some embodiments, each pump 520 may include a water inlet. In some embodiments, the water inlets of the plurality of pumps 520 may have the same orientation. In some embodiments, the orientations of the water inlets of the plurality of pumps 520 may be different or partially different.

In conventional technology, the plurality of pumps 520 of the airborne spraying system 500 share the same main water inlet, and the flow of liquid entering the water inlet of each pump 520 may fluctuate, causing the problem of flow fluctuations among the plurality of pumps 520 (caused by the different flow of liquid entering each pump 520), which will cause the spraying pressure of the airborne spraying system 500 to be unstable. In the present disclosure, in order to reduce the flow fluctuation between the plurality of pumps 520, as shown in FIG. 18, the pump 520 further includes a water separator 540. The water inlet of each pump 520 is connected to the water separator 540. To facilitate the connection of the water separator 540 with the water inlet of each pump 520, the water inlets of the plurality of pumps 520 can face the same direction. In addition, the water inlets of the plurality of pumps 520 can communicate with each other through the water separator 540. The water separator 540 can lead the liquid in the liquid storage tank 200, and then pump it out through the plurality of pumps 520. By using the water separator 540, the flow fluctuation among the plurality of pumps 520 can be improved, and the structure of the main water inlet can be simplified.

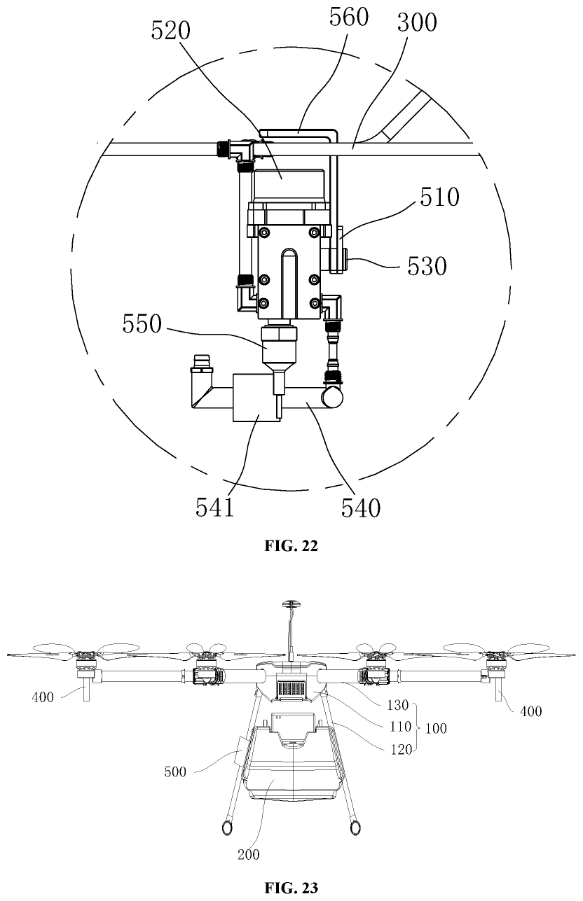

Referring to FIG. 22, an auxiliary water tank 541 is disposed near each water inlet of the water separator 540, and the auxiliary water tank 541 is in communication with the corresponding water inlet. The liquid in the water separator 540 can enter the corresponding pump 520 through the auxiliary water tank 541 and the corresponding water inlet, which further reduces the flow fluctuation between the plurality of pumps 520, and ensures the stability of the spray pressure of the airborne spraying system 500.

In some embodiments, the auxiliary water tank 541 may be made of flexible materials, such as rubber and plastic. The auxiliary water tank 541 made of flexible material can deform and absorb the pulsating pressure caused by the unstable liquid flow in the water inlet, ensuring the stability of the spray pressure of the airborne spraying system 500.

In addition, each pump 520 may also include a water outlet. In some embodiments, the water outlets of the plurality of pumps 520 may have the same orientation and may be opposite to the water inlets. In some embodiments, the orientations of the water outlets of the plurality of pumps 520 may be different or partially different.

In the embodiments of the present disclosure, the pump 520 has a top and a bottom. The water inlet and the water outlet of the pump 520 will be further described with reference to the top as upward and the bottom as downward. In some embodiments, the water inlets of the plurality of pumps 520 may all face downward, and the water outlets of the plurality of pumps 520 may all face upward to facilitate the layout of the pipeline 300.

In order to monitor the real-time pressure change of the pump 520, a pressure detection device is generally installed on the pump 520. The pump 520 can use a built-in pressure detection device. However, due to the pressure vibration, the pressure detection device is easily damage and requires regular maintenance or replacement. When the built-in pressure detection device is damaged, it is troublesome to remove and replace the pressure detection device. Therefore, when the built-in pressure detection device is damaged, the entire pump 520 may need to be scrapped.

Referring to FIG. 18 and FIG. 22, each pump 520 further includes a pressure gauge 550 for detecting pressure changes in the pump 520. The pressure gauge 550 may be detachably connected to the corresponding pump 520. In this embodiment, the pressure gauge 550 is external and detachable. In this way, the pressure gauge 550 is easy to install and remove, and the pressure gauge 550 can be replaced separately without disassembling the pump 520. In some embodiments, the pressure gauge 550 can be detachably connected to the corresponding pump 520 through a screw thread or a flange.

The position where the pressure gauge 550 is connected to the pump 520 can be selected based on needs. In this embodiment, since the pipeline 300 needs to be arranged on top of the pump 520, the pressure gauge 550 is arranged at the bottom of the corresponding pump 520 to facilitate quick disassembly of the pressure gauge 550.

In addition, each pump 520 may also include a driving mechanism 4 as a driving source of the pump 520. The type of the driving mechanism 4 can be selected based on needs. In some embodiments, the driving mechanism 4 may include a motor. The motor can be positioned on the top of the corresponding pump 520 to prevent the pump 520 from the leaked liquid form enter the motor after the pump 520 is damaged or leaked, thereby achieving the purpose of protecting the motor. In some embodiments, the motor may be directly installed on the top of the pump 520. In some embodiments, the motor may be disposed at a certain distance from the top of the pump 520. In some embodiments, the motor may be directly or indirectly fixedly connected to the top of the pump 520. It can be understood that the motor can also be replaced with other driving devices.

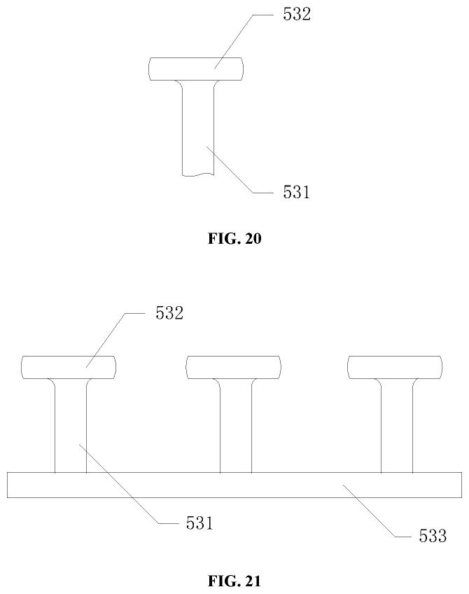

Referring to FIG. 18 and FIG. 20, the airborne spraying system 500 further includes a mounting bracket 560. The mounting bracket 560 can be used for fixedly connection with external devices, and the mounting bracket 560 is fixedly connected with the fixing frame 510. When the airborne spraying system 500 is installed on an external device, the mounting bracket 560 can be fixedly connected to the external device, thereby fixing the airborne spraying system 500 on the external device.

In some embodiments, the mounting bracket 560 and the fixing frame 510 may be detachably fixed connected, and the mounting bracket 560 and the fixing frame 510 may be detachably fixed by any conventional fixing method. For example, the mounting bracket 560 and the fixing frame 510 may be detachably connected based on threads, quick-release parts, or welding. In some embodiments, the mounting bracket 560 and the fixing frame 510 may be integrally formed.

There may be one or more mounting brackets 560. For example, in one embodiment, there may be a plurality of mounting brackets 560, and the plurality of mounting brackets 560 may be disposed on the fixing frame 510 at intervals. When the airborne spraying system 500 is installed on an external device, the plurality of mounting brackets 560 may be fixedly connected to the external device, respectively, thereby stably fixing the airborne spraying system 500 on the external device.

In the embodiments of the present disclosure, the external device may be an agricultural plant protection machine, such as a plant protection UAV, a pesticide spraying vehicle, a manual spraying device, etc. The airborne spraying system 500 described in the embodiments of the present disclosure can be applied to the agricultural plant protection machine to meet the needs large volume spraying and independent control of the plurality of nozzles in the field of plant protection. Take the plant protection UAV as an example, the mounting bracket 560 can be installed on a frame 100 of the plant protection UAV, such that the airborne spraying system 500 can be installed on the frame 100.

Referring to FIG. 23, an embodiment of the present disclosure provides an agricultural plant protection machine. The agricultural plant protection machine includes a frame 100, a liquid storage tank 200 for storing liquid pesticide, a pipeline 300 connected to the liquid storage tank 200, a plurality of nozzles 400, and a pump. The pump can pump pesticides from the liquid storage tank 200 to the plurality of nozzles 400, and the plurality of nozzles 400 can spray the liquid pesticides on the crops.

The agricultural plant protection machine of this embodiment may be a plant protection UAV, a pesticide spraying vehicle, or a manual spraying device.

In some embodiments, the pump may be the pump 520 described in the foregoing embodiments. For the structure of the pump, reference may be made to the foregoing description of the previous embodiments, which will not be repeated here. In this embodiment, the liquid inlet 11 of the pump 520 can communicate with the liquid storage tank 200 through the pipeline 300, and the liquid outlet 12 can communicate with the nozzle 400 through the pipeline 300.

In some embodiments, the pump 520 may be fixedly connected to the frame 100. Take the plant protection UAV as an example, the frame 100 includes a body 110 and a landing gear 120 connected to the bottom of the body 110. The pump body 1 or the pump cover 8 may be disposed at the landing gear 120. The fixed connection method between the pump body 1 or the pump cover 8 may be any conventional fixing method, such as screw thread, snap connection, etc.

Referring to FIG. 23, the frame 100 further include an arm 130 connected to the body 110, and the nozzle 400 is disposed at an end of the arm 130 away from the body 110.

In some embodiments, the pump may also be replaced with the airborne spraying system 500 described in the foregoing embodiments. For the structure of the airborne spraying system 500, reference may be made to the description of the foregoing embodiment, which will not be repeated here.

In some embodiments, the plurality of pumps 520 of the airborne spraying system 500 may be connected between the liquid storage tank 200 and the corresponding nozzle 400 through the pipeline 300. The pump 520 may be used for pumping the liquid pesticide in the liquid storage tank 200 to the corresponding nozzle 400, and the nozzle 400 may spray the liquid pesticide on the crops.

The water separator 540 of the airborne spraying system 500 may include an inlet and a plurality of outlets, and the inlet of the water separator 540 may be in communication with the liquid storage tank 200. In some embodiments, the inlet of the water separator 540 may communicate with the liquid storage tank 200 directly or through a pipeline 300. The water inlet of each pump 520 may communicate with the water separator 540 through an outlet of the water separator 540. In some embodiments, the water inlet of each pump 520 may communicate with the corresponding outlet directly or through a pipeline 300. Further, the water outlet of each pump 520 may communicate with the corresponding nozzle 400 through the pipeline 300. The liquid pesticide in the liquid storage tank 200 may enter the water separator 540 through the inlet of the water separator 540. The water separator 540 may evenly distributes the liquid pesticide to each pump 520, the plurality of pumps 520 may pump the liquid pesticide to the corresponding nozzle 400, and then discharge the liquid pesticide from the nozzle 400 to spray the liquid pesticide on the crops.

The mounting bracket 560 of the airborne spraying system 500 may be fixedly connected to the frame 100. Take a plant protection UAV as an example. The frame 100 may include a body 110 and a landing gear 120 connected to the bottom of the body 110, and the mounting bracket 560 may be fixedly connected to the bottom of the body 110. The fixing connection between the mounting bracket 560 and the bottom of the body 110 may be any conventional fixing method, such as screw thread, snap connection, etc. Referring to FIG. 23, the frame 100 further includes an arm 130 connected to the body 110, and the nozzle 400 is disposed at an end of the 130 away from the body 110.

It should be noted that in the present disclosure, relational terms such as first and second, etc., are only used to distinguish an entity or operation from another entity or operation, and do not necessarily imply that there is an actual relationship or order between the entities or operations. The terms “comprising,” “including,” or any other variations are intended to encompass non-exclusive inclusion, such that a process, a method, an apparatus, or a device having a plurality of listed items not only includes these items, but also includes other items that are not listed, or includes items inherent in the process, method, apparatus, or device. Without further limitations, an item modified by a term “comprising a . . . ” does not exclude inclusion of another same item in the process, method, apparatus, or device that includes the item.

The pump of the agricultural plant protection machine and the agricultural plant protection machine are described above. Examples are used to explain the principles and operations of the various embodiments. The descriptions of the embodiments are only for the purpose of explaining the methods and systems of the present disclosure. A person having ordinary skill in the art can modify or improve the various features of the present disclosure without departing from the principle of the various embodiments disclosed herein. Such modification or improvement also fall within the scope of the present disclosure.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. An agricultural plant protection machine, comprising:
a frame;
a liquid storage tank for storing liquid;
a pipeline connected to the liquid storage tank;
a nozzle; and
a pump for pumping the liquid in the liquid storage tank to the nozzle, the pump including:
a pump body including a liquid inlet, a liquid outlet, and a pressure relief port, the liquid inlet being connected with the liquid outlet through a flow channel, the liquid inlet being connection with liquid storage tank through the pipeline, the liquid outlet being connected with the nozzle through the pipeline, the pressure relief port being connected to the flow channel;
a pressure relief device disposed at the pressure relief port, the pressure relief device including a valve and an elastic reset member, the valve being disposed corresponding to the pressure relief port for sealing the valve, the elastic reset member being connected to the valve to provide an elastic restoring force to the valve and configured to cause the valve to seal the pressure relief port under action of the elastic restoring force; wherein
in response to a hydraulic pressure in the pump body exceeding a preset pressure threshold, the valve is separated from the pressure relief port under the force of the liquid and the liquid flows out of the pressure relief port.

2. The agricultural plant protection machine of claim 1, wherein:
the pressure relief device further includes a cover, the cover being fixedly connected to the pump body, and the elastic reset member being movably connected to the cover; and
the elastic reset member is configured to apply different magnitudes of the elastic restoring force to the valve when the elastic reset member moves to different positions relative to the cover, the valve is configured to seal the pressure relief port under the action of the elastic restoring force exerted by the elastic reset member.

3. The agricultural plant protection machine of claim 2, wherein;
the cover includes a first opening, the elastic reset member being movably inserted into the first opening; and
the elastic reset member is configured to apply different magnitudes of the elastic restoring force to the valve when the elastic reset member moves to different positions relative to the first opening.

4. The agricultural plant protection machine of claim 2, wherein:
the pressure relief device further includes an adjusting member and the cover includes a first opening, one end of the elastic reset member being connected to the valve, and an other end being connected to the adjusting member, the adjusting member being rotatably inserted into the first opening; and
the adjusting member is configured to drive an expansion and a contraction of the elastic reset member to adjust the magnitude of the elastic restoring force when the adjusting member rotates relative to the first opening in the first opening.

5. The agricultural plant protection machine of claim 4, wherein:
the elastic reset member is a spring;
the adjusting member is a threaded piece; and
a fixed end is disposed on a surface of the valve facing away from the pressure relief port, one end of the spring being sleeved on the fixed end, and an other end being sleeved on the threaded piece.

6. The agricultural plant protection machine of claim 5, wherein:
a part of the adjusting member penetrates the first opening to be exposed outside the first opening.

7. The agricultural plant protection machine of claim 2, wherein:
a poppet valve is disposed on a side of the valve facing the pressure relief port, the poppet valve being plugged into the pressure relief port.

8. The agricultural plant protection machine of claim 2, wherein:
the valve is made of a flexible material.

9. The agricultural plant protection machine of claim 2, further comprising:
the cover is disposed at the pressure relief port, and the cover and the pump body surround and enclose a receiving space, the valve being disposed in the receiving space and fixedly connected with an inner side wall of the cover.

10. The agricultural plant protection machine of claim 2, wherein:
the pressure relief device further includes a travel switch, the elastic reset member abutting against one end of the valve, and the travel switch abutting against an other end of the valve.

11. The agricultural plant protection machine of claim 10, wherein:
the cover includes a second opening, the travel switching being movably inserted into the second opening.

12. The agricultural plant protection machine of claim 10, further comprising:
an auxiliary member disposed on a surface of the valve opposite to the pressure relief port, the travel switch and the elastic reset member abutting against the valve through the auxiliary member.

13. The agricultural plant protection machine of claim 12, wherein:
a third opening is disposed at the auxiliary member; and
the elastic reset member penetrates the third opening to be connected to the valve, or
a part of the valve penetrates the third opening to be connected to the elastic reset member.

14. The agricultural plant protection machine of claim 12, wherein:
the auxiliary member is fixedly connected to a surface of the valve facing away from the pressure relief port; and
the cover is configured to cover the pressure relief port, the cover and the pump body surround and form a receiving space, the auxiliary member being disposed in the receiving space and movably connected with an inner side wall of the cover.

15. The agricultural plant protection machine of claim 12, wherein:
the auxiliary member has a rigid sheet-like structure.

16. The agricultural plant protection machine of claim 1, wherein:
the pump body further includes a liquid return port, the liquid return port being connection with the flow channel, and the pressure relief port being connected with the liquid return port through a return channel.
